(19) United States
(12) Patent Application Publication
(10) Pub. No.: US 2013/0342484 A1
(43) Pub. Date: Dec. 26, 2013

(54) ELECTRONIC DEVICE HAVING FLOATING PANEL

(71) Applicant: Samsung Electronics Co., Ltd., Gyeonggi-do (KR)

(72) Inventors: Yu-Dong BAE, Gyeonggi-do (KR); Ho-Seong Seo, Gyeonggi-do (KR); Young-Min Lee, Gyeonggi-do (KR); Eun-Hwa Lee, Gyeonggi-do (KR); Jeong-Seok Lee, Gyeonggi-do (KR)

(21) Appl. No.: 13/922,986

(22) Filed: Jun. 20, 2013

(30) Foreign Application Priority Data
Jun. 26, 2012 (KR) 10-2012-0068623

(51) Int. Cl. G06F 3/01

(52) U.S. Cl. CPC G06F 3/016
USPC 345/173

(57) ABSTRACT

Disclosed is an electronic device having a floating panel. The electronic device includes a display bracket; a panel provided on the front side of the display bracket and configured to sense a touch input and to provide visual information; an actuator provided on the panel, and configured to provide a haptic signal corresponding to the touch input; an elastic member provided between the panel and the display bracket, and configured to elastically support the panel to float in a state in which the panel is spaced from the display bracket; and a stopper configured to fix the panel, which is lifted and supported by the elastic member, to the display bracket in a floating state.

### PRIORITY

This application claims priority under 35 U.S.C. §119(a) to Korean Application Serial No. 10-2012-0068623, which was filed in the Korean Intellectual Property Office on June 26, 2012, the entire content of which is hereby incorporated by reference.

### BACKGROUND OF THE INVENTION

1. Field of the Invention

The present invention relates generally to an electronic device, and more particularly, to an electronic device which is provided with a floating panel configured to float from the body of the electronic body so as to make a haptic feedback analogous with a real button pushing feeling.

2. Description of the Related Art

Currently, the term “electronic device” refers to a device which allows a user to enjoy various contents while carrying the device, for example, a portable terminal, an MP3 player, a Portable Multimedia Player (PMP), or an electronic book. Portable devices are frequently used while moving due to easy and convenient portability and various functions incorporated therein. Such portable electronic devices have diverse functions, typically according to consumers' demands or the like.

Recently, bar-type portable terminals, such as smart phones and tablet PCs, in which various functions are incorporated, have become increasingly popular. In particular, a portable electronic device with a full-touch screen provides a haptic feedback in such a manner that when touching an icon that is displayed on the screen, the user can recognize it as if the user touches or pushes a real button simultaneously while touching the icon. That is, a haptic feedback device is frequently employed, in which the haptic feedback device includes a concept of reflecting a user's intuitive experience and further diversifying a feedback by an interface, as well as providing for inputting data by the user's touching The term “haptic” refers to a tactile sense felt by a person's finger tip when touching an object, and includes a tactile feedback felt when a skin comes into contact with a surface of an object. A technology related to such a haptic feedback device is disclosed in Korean Unexamined Laid-open Publication No. 10-2011-0075714 published on Jul. 6, 2011, and Korean Patent No 10-1046017 registered on Jun. 27, 2011.

The haptic feedback, which is provided when touching a panel of an electronic device provided with such a haptic feedback device, may provide a sufficient vibrating force to provide a haptic feedback when the electronic device is held in the user's hand. However, there is a problem in that when the electronic device is used in a state in which it is laid on a floor, the haptic feedback may not be properly transmitted to the user because the vibrating force is too week. In order to solve this problem, there has been proposed a configuration in which the panel is installed to be floatable in relation to the body of the electronic device rather than to be fixed to the body of the electronic device, as disclosed in U.S. Pat. No. 7,999,660 registered on Aug. 16, 2011.

However, the electronic device provided with a floating panel has a problem in that because a structure for installing the panel to the body of the electronic device is not stable, the electronic device exhibits instability to such an extent that when the electronic device endures a shock, for example due to the drop of the electronic device, the panel may disconnect from the electronic device.

### SUMMARY OF THE INVENTION

Accordingly, an aspect of the present invention is to solve at least the above-described problems occurring in the prior art, and to provide at least the advantages described below.

Another aspect of the present invention is to provide an electronic device having a floating panel, in which the panel is adapted to be vibrated in its floating state so that when haptic feedback is provided when the panel in the electronic device is contacted, the haptic feedback to the panel can be maximized. The panel is stably fixed to the electronic device in the floating state so that mechanical stability can be ensured even when the electronic device endures a shock, for example, due to the electronic device being dropped.

In accordance with another aspect of the present invention, there is provided an electronic device having a floating device. The electronic device includes a display bracket; a panel provided on a front side of the display bracket and configured to sense a touch input and to provide visual information; an actuator provided on the panel, and configured to provide a haptic signal corresponding to the touch input; an elastic member provided between the panel and the display bracket, and configured to elastically support the panel to float in a state in which the panel is spaced from the display bracket; and a stopper configured to fix the panel, which is lifted and supported by the elastic member, to the display bracket in a floating state.

The stopper includes a first locking plate that is bent and protrudes toward the display bracket along the periphery of the panel; a second locking plate that is bent and protrudes toward the panel along the periphery of the display bracket, the second locking bracket being engaged with the first locking plate in such a manner that the second locking plate forms a space in cooperation with the first locking plate to limit vertical movement of the panel; and an elastic body that is provided in the space to provide resilience according to the floating of the panel, and to limit horizontal movement of the panel.

In accordance with still another aspect of the present invention, there is provided an electronic device having a floating panel, including a display bracket; a panel provided on a front side of the display bracket and configured to sense a touch input and to provide visual information; an actuator provided on the panel, and configured to provide a haptic signal corresponding to the touch input; and a stopper member configured to elastically support the panel in a state in which the panel floats in spaced relation from the display bracket, and to limit a displacement space for the panel when the panel is being vibrated.

The stopper member includes an elastic member provided between the panel and the display bracket, and configured to elastically support the panel to float in a state in which the panel is spaced from the display bracket; and a stopper configured to limit a displacement space for the panel when vibrated as the actuator is driven, and to suppress the escaping of the panel when the panel is floating.

The elastic member includes a plate that is provided between the bottom side of the panel and the display bracket, and is formed with a plurality of elastic strips on the display bracket side; and a peripheral area integrally extending from the periphery of the plate and configured to be engaged with the periphery of the panel, the peripheral area being formed with a stopper joint section, and the stopper being joined to the stopper joint section.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a cross-sectional view schematically illustrating an electronic device having a floating panel according to an embodiment of the present invention in a state in which the panel is supported to float by an elastic support unit;

FIG. 2 is a cross-sectional view schematically illustrating the electronic device of FIG. 1 in a state in which the panel floats from the body of the electronic device at the maximum as a contact is produced in the panel in the electronic device, thereby driving an actuator;

FIG. 3 is an exploded perspective view schematically illustrating an electronic device having a floating panel according to another embodiment of the present invention which is provided with a stopper and an elastic member which are different from those of the electronic device of FIGS. 1 and 2;

FIG. 4 is a cross-sectional view of a central portion of the electronic device of FIG. 3 in a state in which the components of FIG. 3 are assembled;

FIG. 5 is a cross-sectional view of an end portion of the electronic device in a state in which the components of FIG. 3 are assembled;

FIG. 6 illustrates an elastic chassis of a stopper member of FIG. 3 in an enlarged scale;

FIG. 7 illustrates a state in which the panel is positioned on one side of the elastic chassis and the display bracket is positioned on the other side;

FIG. 8 is an enlarged view of one of the stoppers of the stopper member illustrated in FIG. 3;

FIG.9 illustrates how a stopper is mounted; and

FIG. 10 illustrates how a stopper bracket is fastened to the arrangement section above a stopper fixed to the arrangement section.

### DETAILED DESCRIPTION OF EMBODIMENTS OF THE PRESENT INVENTION

Hereinafter, embodiments of an electronic device provided with the inventive floating panel will be described with reference to the accompanying drawings. In connection with this, the lines and components may be exaggeratedly illustrated in terms of thickness and size in the drawings for clarity and convenience of description. In addition, the terminologies in the following description are those defined in consideration of functions in the present invention, and may be changed according to an intention of a user or an operator, or a practice. Thus, the definitions for those terminologies should be determined based on the contents provided in the entirety of the present invention.

Furthermore, although ordinal numbers, such as first and second, are used in the examples of the present invention described below merely to differentiate the objects with the same name from each other, the order of the objects may be arbitrarily determined and a preceding description may be applied to a postfix element.

In particular, the present invention provides an electronic device having a panel and configured in such a manner that the panel is adapted to be stably joined while being maintained in a floating state in which the panel floats from the body of the electronic device, and even when the panel is vibrated due to an actuator, the panel is adapted to be vibrated in a limited displacement in a state in which the panel is stably fixed to the body of the electronic device.

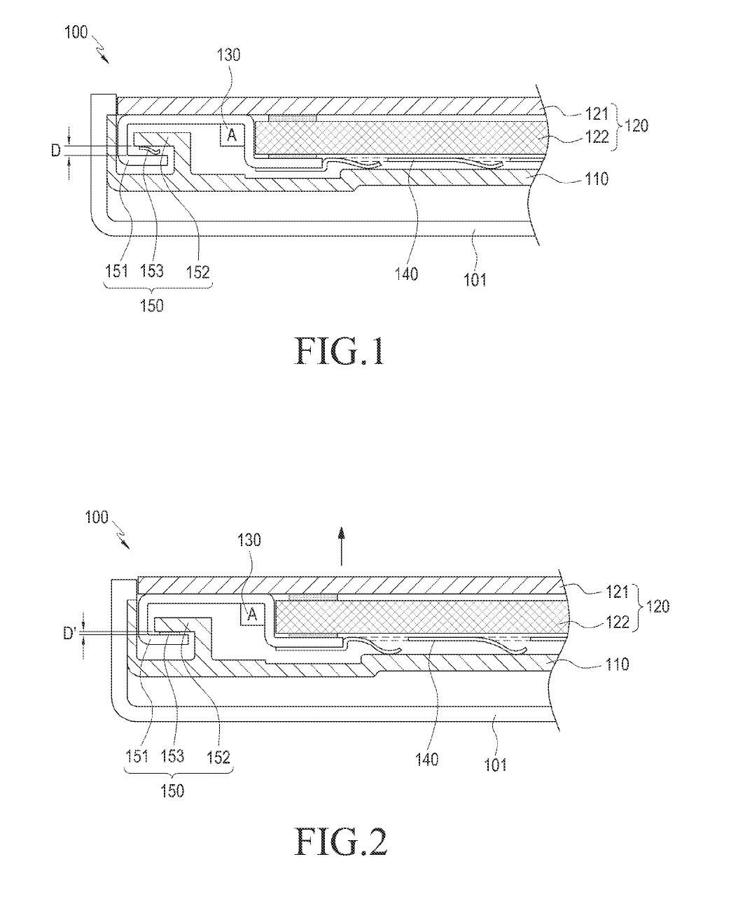

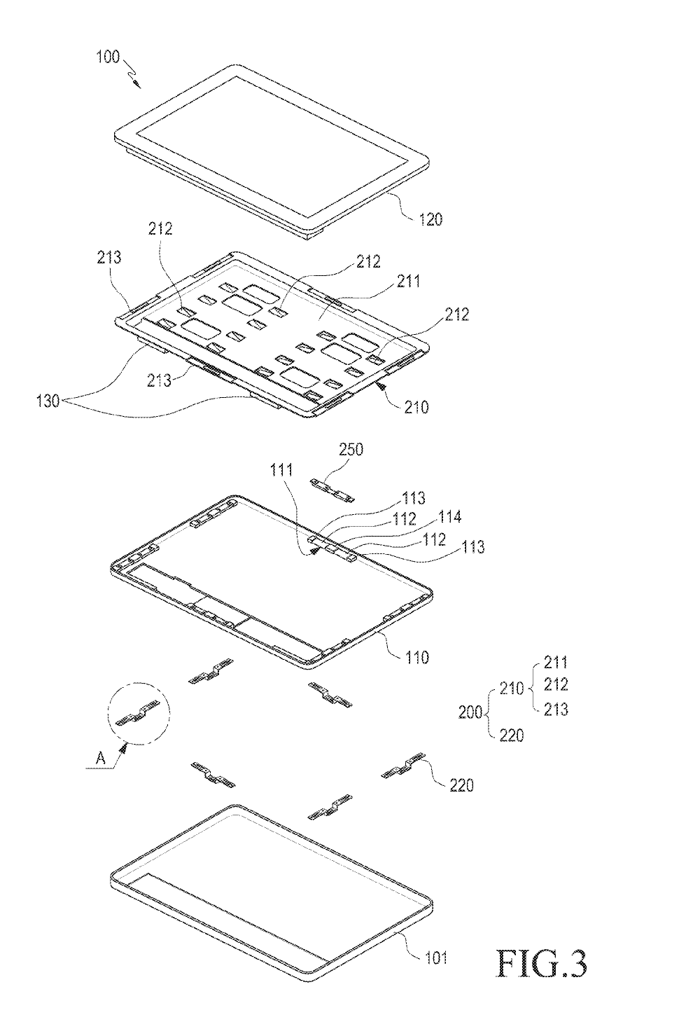

Now, an electronic device having a floating panel will be described with reference to FIGS. 1 to 10. For reference, FIGS. 1 and 2 schematically illustrate an embodiment configured in such a manner that a panel to be described later is stably joined in a floating state in which the panel floats from a display bracket, and the displacement of the panel is limited when the panel is vibrated. FIGS. 3 to 10 illustrate another embodiment which is the same as the embodiment of FIGS. 1 and 2 in terms of basic functions, but different from the embodiment of FIGS. 1 and 2 in terms of constitutional components. However, the embodiment of FIGS. 3 to 10 is the same as the embodiment of FIGS. 1 and 2 in that a space is formed in order to allow the panel to be stably fixed in the floating state and to limit the displacement of the panel when the panel is vibrated.

FIG. 1 is a cross-sectional view schematically illustrating an electronic device having a floating panel according to an embodiment of the present invention, in a state in which the panel is supported to float by an elastic support unit, and FIG. 2 is a cross-sectional view schematically illustrating the electronic device of FIG. 1 in a state in which the panel floats from the body of the electronic device at a maximum distance as the panel of the electronic device is contacted, thereby driving an actuator. Referring to FIGS. 1 and 2, the electronic device 100 includes a body 101, a display bracket 110, a panel 120, an actuator 130, an elastic member 140, and a stopper 150.

The display bracket 110 is provided with panel 120 (more specifically, an LCD panel 122 and a touch screen panel 121), and a printed circuit board (not shown) on the top side thereof, and is configured to be fixed to the body 101 of the electronic device 100.

The panel 120 includes the LCD panel 122, and the touch screen panel 121, and is installed on the front side of the body 101, i.e., the front side of the display bracket 110. The panel 120 is provided in such a manner that the electronic device 100 has a full screen on the front side of the body 101, but not limited thereto. The panel 120 senses a contact by a user's finger or an input device, for example, a stylus pen, for pushing a button or inputting data by the touch screen panel 121, and visually displays input button information or data information through the LCD panel 122. The panel 120 is configured to be vertically floatable from the body 101, and more specifically, is spaced from the display bracket 110 by an elastic member 140. When the actuator 130 is driven in the state in which the panel 120 is floating from the body 101, the panel 120 is elastically supported to vertically float by the elastic member 140. At this time, the floating panel 120 is confined in a displacement space D to be vibrated by the actuator 130 within a predetermined displacement defined by the elastic member 140 and the stopper 150. Accordingly, as the actuator 130 is driven, the panel 120 is vibrated only within the defined displacement space D vertically (in the present embodiment, in a direction perpendicular to the panel 120), thereby providing a haptic feedback to the user who contacts the panel 120.

The actuator 130 implements a haptic signal, for example, vibration to the panel 120 according to the button input, i.e. the contact sensed by the panel 120, thereby providing the haptic feedback to the user. The actuator 130 is installed below the panel 120, and the panel 120 is provided in a state in which it is floating from the display bracket 110. Thus, all the vibration produced by the actuator 130 may be provided to the panel 120 rather than to the body 101 of the electronic device 100.

The elastic member 140 and the stopper 150 are configured to stably fix the panel 120 in the state in which the panel 120 is floating from the display bracket 110, and to secure the displacement space D to ensure that the floating panel 120 is stably vertically vibrated in the fixed state as well as to limit the vibration displacement when the panel 120 is vertically vibrated by the actuator 130 with respect to the display bracket 110.

Now, the elastic member 140 will be discussed. Referring to FIGS. 1 and 2, the elastic member 140 is provided between the panel 120 and the display bracket 110, and is configured to elastically support the panel 120 in such a manner that the panel 120 is maintained in the state in which it is lifted from the display bracket 110 by a predetermined distance to define a predetermined space. The elastic member 140 elastically supports the panel 120 in such a manner that the panel 120 is maintained in the lifted state with the predetermined space from the display bracket 110. In addition, when the panel 120 is vertically vibrated in relation to the display bracket 110 by the actuator 130, the elastic member 140 provides an elastic force in such a manner that the panel 120 is vibrated in the state in which it is floating from the display bracket 110. The elastic member 140 may include, for example, a plurality of leaf springs or other types of springs, as illustrated in FIGS. 1 and 2. Alternatively, as illustrated in FIGS. 3 to 10, for example, an elastic chassis 210 provided with a plurality of elastic strips 212, which may also be leaf springs, may be provided below the entirety of the bottom side of the panel 120, which will be described with reference to FIGS. 3 to 10.

Next, a description will be made for the stopper 150 that is configured to provide a displacement space D for the display panel 120 when the panel 120 is floating from the display bracket 110 and is vibrated, in cooperation with the elastic member 140. Initially, a function of the stopper 150 is to stably fix the panel 120, which is configured to float by the elastic member 140, to the body 101 of the electronic device 100. That is, the stopper 150 is adapted to prevent the panel 120 in the floating state from being easily separated from the body even when the panel 120 endures a shock in its floating state. In addition, the stopper 150 is also configured to limit the displacement of the panel 120 in such a manner that the panel 120 can be moved only within the displacement space D while stably maintaining the fixed state of the panel 120 to the display bracket 110 when the panel 120 is moved vertically in relation to the display bracket 110 as the actuator 130 is driven to vibrate the panel 120 in the floating state.

The stopper 150 includes a first locking plate 151, a second locking plate 152, and an elastic body 153. As described above, the first locking plate 151 is configured to be installed around the periphery of panel 120 under the panel 120. The first locking plate 151 is bent to protrude toward the display bracket 110, and bent in an “L” shaped cross-section to the bottom side of the peripheral area of the panel 120. The second locking plate 152 is configured to be engaged with, or hooked with, the first locking plate 151 with a predetermined gap in relation to the first locking plate 151. That is, the second locking plate 152 is bent to protrude toward the panel 120 along the periphery of the display bracket 110, and may be part of display bracket 110, and is engaged with the first locking plate 151 to provide a displacement space D between the bent end and the first locking plate 151 so as to limit the vertical movement of the panel 120. The second locking plate 152 has a “┐” shaped cross-section (or inverted “L” shaped cross-section) which extends toward the panel 120 and then is bent above the display bracket 110 so that the second locking plate 152 is engaged with the first locking plate 151 of the “L” shaped cross-section. That is, when the panel 120 is lifted toward the top side of the body 101 of the electronic device 100 as the actuator 130 is driven, the displacement space D between the first locking plate 151 and the second locking plate 152 is reduced (D→D′), and the panel 120 is lifted, as seen in FIG. 2. At this time, the elastic body 153 between the first and second locking plates 151 and 152 is resiliently deformed and then returned to its original state. As a result, the panel 120 is allowed to be vibrated vertically while stably maintaining the fixed state in the displacement space D. Although it is shown that the first locking plate 151 is provided below the panel 120 and the second locking plate 152 is integrally formed with the display bracket 110, stopper 150 is not limited thereto. Various modifications are possible to provide, for example, a configuration as illustrated in FIGS. 5 to 10 in which a displacement space is provided to ensure stable engagement.

Elastic body 153 is accommodated in the displacement space in the state in which the first locking plate 151 and the second locking plate 152 are engaged with each other. The elastic body 153 is configured to provide resilience for allowing the second locking plate 152 to remain in its original position when the displacement space D between the first locking plate 151 and the second locking plate 152 is narrowed as the panel 120 in the floating state is lifted as the actuator 130 is driven, and the elastic body 153 may absorb shock caused when the first locking plate 151 and the second locking plate 152 contact each other due to the vibration of the panel 120. The elastic body 153 may be formed from at least one of poron, foam, and a spring, but is not limited thereto.

FIG. 3 is an exploded perspective view schematically illustrating an electronic device with a floating panel according to another embodiment of the present invention, which is provided with a stopper and an elastic member which are different from those of the electronic device of FIGS. 1 and 2. Like the electronic device of FIGS. 1 and 2, the electronic device 100 of the embodiment of FIG. 3 generally includes a body 101, a display bracket 110, a panel 120, an actuator 130, and a stopper member 200. The embodiment of FIG. 3 is differentiated from the embodiment of FIGS. 1 and 2 by the stopper member and the display bracket 110 which is modified due to the construction of the stopper member. Because the panel 120 and the actuator 130 are the same as those of FIGS. 1 and 2, they are not described in further detail.

In FIG. 3, the stopper member includes an elastic chassis 210 and a plurality of stoppers 220. The arrangement sequence of these components is as follows: the elastic chassis 210 is disposed below the panel 120, the display bracket 110 is laid below the elastic chassis 210, and the stoppers 220 of the stopper member 200 are fastened in this state. The elastic chassis 210 is provided between the panel 120 and the display bracket 110, and configured to elastically support the panel 120 to float in the floating state in which the panel 120 is spaced away from the display bracket 110.

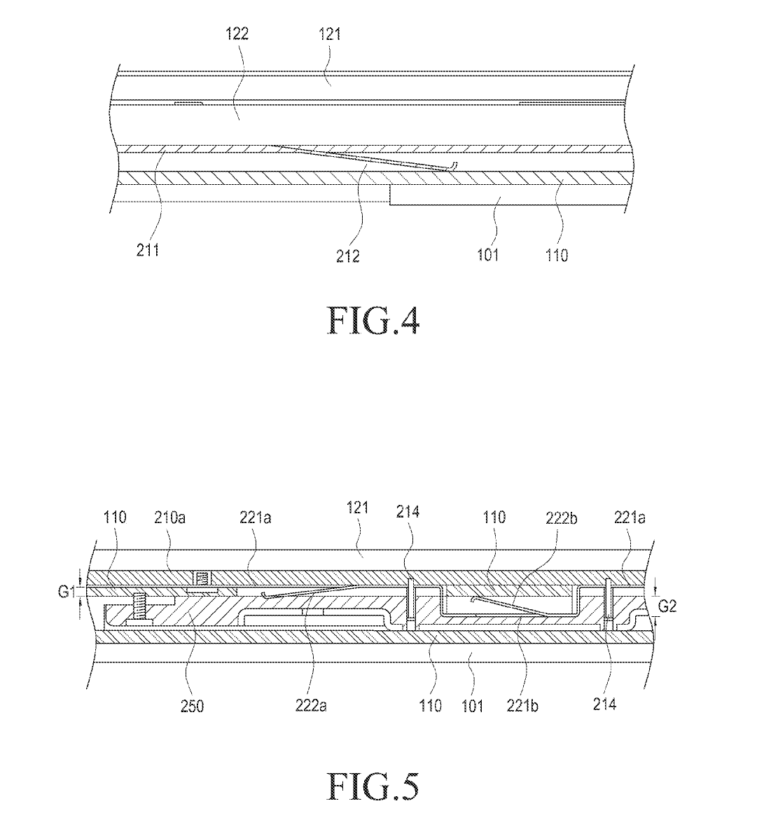

FIG. 4 is a cross-sectional view of a central portion of the electronic device of FIG. 3 in a state in which the components of FIG. 3 are assembled, and FIG. 5 is a cross-sectional view of an end portion of the electronic device in a state in which the components of FIG. 3 are assembled.

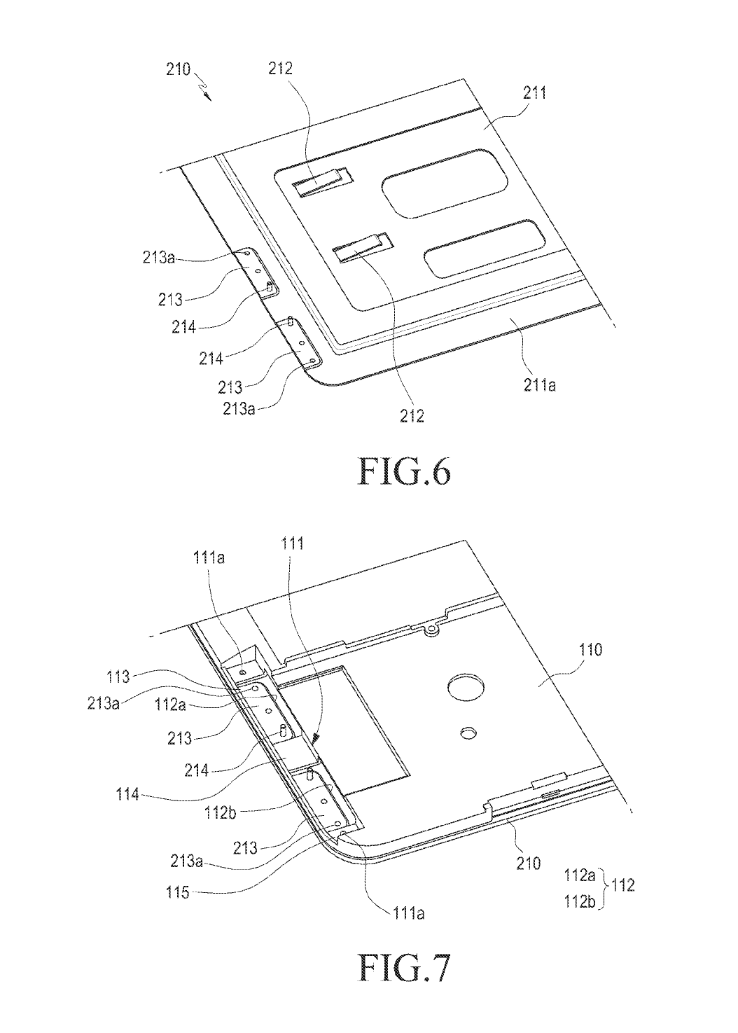

FIG. 6 illustrates the elastic chassis of the stopper member of FIG. 3 in an enlarged scale.

Referring to FIG. 6, the elastic chassis 210 may include a plate 211, which is formed with one or more stopper joint sections 213. The plate 211 is provided between the bottom of the panel 120 and the display bracket 110, and is preferably formed in a size substantially the same as that of the panel 120. The plate 211 is integrally formed with a plurality of elastic strips 212, for example, leaf springs which protrude toward the display bracket 110. The elastic strips 212 elastically support the panel 120 in the floating state, i.e. in the state in which the panel 120 is floating from the body 101 of the electronic device, and more specifically, from the display bracket 110. In addition, the plate 211 joined to the bottom side of the panel 120 is equipped with an actuator 130 so that as the actuator 130 is driven, the elastic strips 212 are vibrated, and the vibration of the elastic strips 212 is directly transmitted to the panel 120. Because the panel 120 is provided in the floating state, the vibration is further increased.

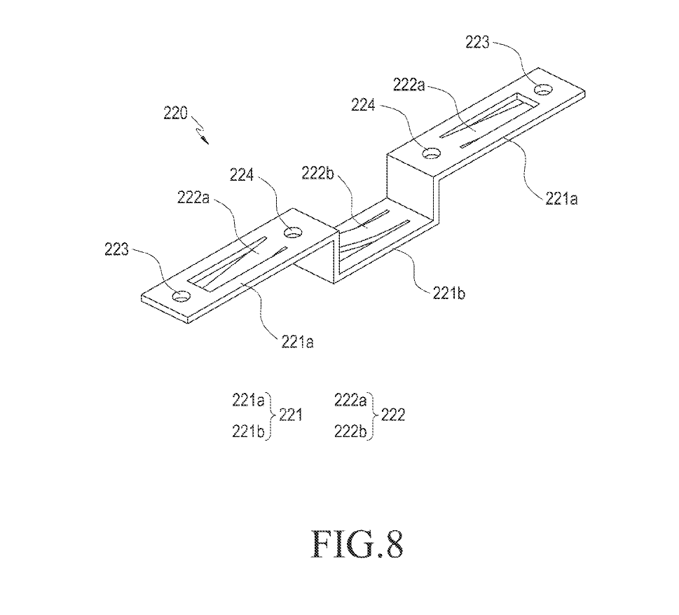

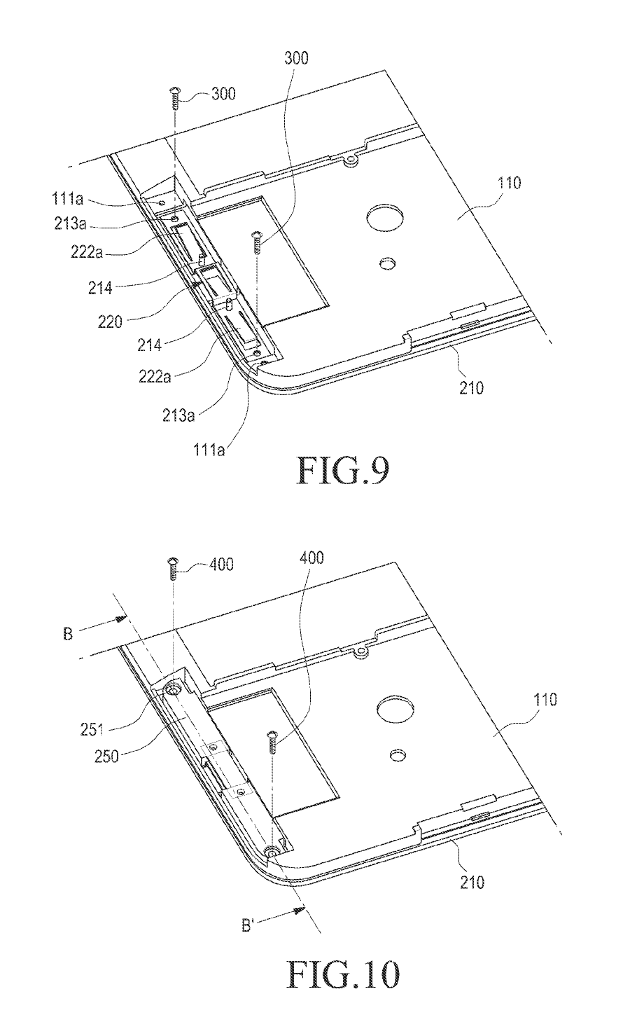

The plate 211 is formed with the plurality of stopper joint sections 213 around the peripheral area thereof, and the stoppers 220 (to be described later) are joined to the stopper joint sections 213, respectively. Each stopper joint section 213 is formed with at least one joint hole 213a, and a fastening member 300 (see FIG. 9) extending through a fastening hole 223, which is formed in each of the stoppers 220 (see FIG. 8), is joined to the joint hole 213a. In addition, each stopper joint section 213 is provided with a vertical fixing pole 214 which vertically protrudes from the stopper joint section 213, in which the vertical fixing pole 214 extends through a stopper 220 to be joined to the stopper joint section 213. The vertical fixing pole 214 is fitted to the stopper 220 to prevent the stopper 220 from being moved left and right. Particularly, the vertical fixing pole 214 is fixed to an end side of an elastic body 222 of the elastic stopper 220 (see FIG. 8) to allow the vertical movement of the stopper 220 by the elastic force of the elastic body 222, but to limit the horizontal movement of the stopper 220. As the stopper 220 is fixed to the stopper joint section 213 through the fastening member 300 and the vertical fixing pole 214, when the panel 120 is vibrated in its floating state, the elastic body 222 is prevented from being moved left and right between the display bracket 110 and the panel 120, to suppress the horizontal movement of the stopper 220, so that the stopper 220 can be stably joined.

FIG. 7 illustrates a state in which the panel is positioned on one side of the elastic chassis and the display bracket is positioned on the other side. Referring to FIG. 7, the display bracket 110 is disposed below the elastic chassis 210. Around the peripheral area of the display bracket 110, a plurality of arrangement sections 111 are formed to positionally correspond to the stopper joint sections 213, respectively, and the stoppers 220 are positioned in the arrangement sections 111, respectively. Each arrangement section 111 is formed with at least one opening 112 such that a stopper 220 is fastened to the stopper joint section 213 through the display bracket 110. Specifically, each arrangement section 111 formed with two openings, i.e., first and second openings 112a and 112b. The first and second openings 112a and 112b are formed to be spaced from each other. Accordingly, the arrangement sections 111 are formed around the peripheral area of the display bracket 110, in which each arrangement section 111 includes a first side portion 113, a first opening 112a, a central portion 114, a second opening 112b, and a second side portion 115 which are formed in this order along the peripheral direction of the display bracket 110. Accordingly, a side portion of a stopper 220 (hereinafter, referred to as a “first body portion 221a”) is engaged in the first opening 112 in such a manner that the first body portion 221a of the stopper 220 (see FIG. 8) and the first opening 112 are opposed to each other, and the other side portion of the stopper 220 (hereinafter, referred to as a “second body portion 221a”) is engaged in the second opening 112 in such a manner that the second body portion 221a of the stopper 220 and the second opening 112 are opposed to each other. In addition, a central area between the first body portion 221a and the second body portion 221a of the stopper 220 (hereinafter, referred to as a “central body portion 221b”) is opposed to the central portion 114 of the arrangement section 111 between the first and second openings 112a and 112b. Accordingly, the stopper 220 and the elastic chassis 210 are integrally joined with each other, and the display bracket 110 is allowed to be inserted and fastened between the elastic chassis 210 and the stopper 220.

FIG. 8 is an enlarged view of one of the stoppers of the stopper member illustrated in FIG. 3, and FIGS. 9 and 10 illustrate how to mount such a stopper and a stopper bracket, respectively.

Referring to FIGS. 8 and 9, the stopper 220 limits the displacement space D for the panel 120 vibrated as the actuator 130 is driven, and prevents the panel 120 from separating from the body 101, i.e. from the display bracket 110 when the panel 120 is floating. As the stopper 220 is joined to the elastic chassis 210 through the display bracket 110, the display bracket 110, and more specifically, the central portion 114 of the arrangement section 111 is arranged between the stopper 220 and the elastic chassis 210, whereby the joined structure is illustrated in the cross-sectional views of FIGS. 1 and 2 can be obtained around the peripheral area of the electronic device.

Each stopper 220 includes a body part 221 and an elastic body 222. The body part 221 is seated on an arrangement section 111, fitted through the openings 112 at the opposite side portions of the body part 221 from the bottom side of the display bracket 110, and fastened to a stopper joint section 223. The body part 221 includes a first body portion 221a, a central body portion 221b, and a second body portion 221a. That is, the body part 221 includes first and second body portions 221a and 221a fitted through the first and second openings 112a and 112b from the bottom side of the display bracket 110 and fastened to the stopper joint section 213, and a central body portion 221b bent and extending between the first and second body portions 221a and 221a and opposed to the central portion 114 of the arrangement section 111. Accordingly, the body part 221 has a shape corresponding to a hat shape in cross-section (‘ [symbol] ’).

From each of the first and second body portions 221a and 221a, an elastic body 222 integrally protrudes. Specifically, the first and second body portions 221a and 221a are formed with first and second leaf springs 222a and 222a, respectively, and the central body portion 221b is formed with a central leaf spring 222b. The first leaf spring 222a has a shape slantingly protruding from the first body portion 221a in a direction away from the panel 120, i.e. toward the display bracket 110. In the present embodiment, the first leaf spring 222a is bent to be slanted from the bent edge of the first body portion 221a toward an end of the first body portion 221a, and protrudes in the direction away from the panel 120. The second leaf spring 222a has a shape slantingly protruding from the second body portion 221a in the direction away from the panel 120, i.e. toward the display bracket 110. In addition, the second leaf spring 222a is formed to be symmetrical to the first leaf spring 222a with reference to the central body portion 221b. That is, the second leaf spring 222a is bent at the bent edge of the second body portion 221a to be slanted toward the end of the second body portion 221a and protrudes in the direction away from the panel 120. In addition, the central leaf spring 222b has a shape slantingly protruding from the central body portion 221b in the direction different from that of the first and second leaf springs 222a, i.e. toward the panel 120. The central leaf spring 222b is bent to be slanted from one side of the central body portion 221b to the other side, and protrudes toward the panel 120. As a result, with reference to FIG. 5, when a space G1 in which first and second leaf springs 222a and 222a are moved, and a space G2 for the central leaf spring 222b is compressed as the panel 120 is vibrated, the first and second leaf springs 222a and 222a apply resilience to the panel 120, and the central leaf spring 222b applies resilience to the display bracket 110 of the panel 120.

Referring to FIG. 9, in order to fasten such a stopper 220 to a stopper joint section 213, the stopper 220 is formed with fastening holes 223 to positionally conform to the joint holes 213a formed in the stopper joint section 213. In the present exemplary embodiment, the fastening holes 223 are formed at an end of the first body portion 221a and an end of the second body portion 221a, respectively. In the state in which the plate 211 is fastened between the panel 120 and the stopper 220, the stopper 220 is seated on the stopper joint section 213 through the first and second openings 112a and 112b, and then fastening members 300 are inserted through the fastening holes 223 and fastened to the joint holes 213a. Then, the stopper 220 is mounted on the stopper joint section 213 with the display bracket 110 being interposed between the central body portion 221b and the stopper joint section 213.

FIG. 10 illustrates how to fasten a stopper bracket to the arrangement section illustrated in FIG. 7. Referring to FIG. 8, openings 224 are formed through the first body portion 221a and the second body portion 221a adjacent to the bent parts of the first body portion 221a and the second body portion 221a, respectively, in which the positions of the openings 224 correspond to those of the vertical fixing poles 214 protruding from the stopper joint section 213, so that the vertical fixing poles 214 extend through the openings 224, respectively, as shown in FIG. 9. As a result, when the stopper 220 is fastened to the stopper joint section 213, the vertical fixing poles 214 protruding from the stopper joint section 213 can be fitted to the stopper 220. More specifically, when the stopper 220 is seated on the stopper joint section 213, the vertical fixing poles 214 are fitted to the openings 224, thereby preventing the stopper 220 from being moved horizontally.

In the state in which the panel 120, the plate 211, the display bracket 110, and the stopper 220 are fastened in this order, as shown in FIG. 10, a stopper bracket 250 is further provided on the arrangement section 111 of the display bracket 110 where the stopper 220 is disposed, in which the stopper bracket 250 is configured to cover the stopper 220 and to be coupled with the arrangement section 111. The stopper bracket 250 covers the stopper 220 in such a manner that the stopper 220 can be stably positioned on the stopper joint section 213 and the arrangement section 111, whereby the stability and reliability of the stopper 220 when the panel 120 in the floating state is vibrated can be improved. In addition, the stopper bracket 250 serves to support the elastic bodies 222a and 222b of the stopper 220. In order to mount the stopper bracket 250 on the arrangement section 111, fastening openings 111a are formed through the first side portion 113 and the second side portion 115 of the arrangement section 111, respectively, as shown in FIGS. 7 and 9. Thus, as fastening members 400 are fastened through holes 251 of the bracket stopper 250, the stopper bracket 250 is fixed to the display bracket 110 while covering the stopper 220.

An actuator 130 is disposed below the panel 120. In the present embodiment, the plate 211 is provided below the panel 120, and the actuator 130 is installed on the bottom side of the plate 211 to transmit vibration to the panel 120, thereby providing a haptic feedback.

The panel 120 assembled in this manner is elastically supported by the elastic chassis 210, specifically by the elastic strips 212 in the floating state, so that the panel 120 floats so as to be spaced from the display bracket 110 (see FIGS. 3 and 6). In this state, if a user touches the panel 120, the touched panel 120 determines contact or pushing, and a controller (not illustrated) controls the driving of the actuator 130 according to the determination of the panel 120. When the actuator 130 provided on the bottom side of the plate 211 is vibrated, the panel 120 floating from the display bracket 110 by the elastic strips 212 is vibrated in the floating state. In addition, because the actuator 130 is provided below both of the floating panel 120 and the plate 211, a maximum vibration produced by the actuator 130 is transmitted to the panel 120.

Thus, the panel can be stably fixed to the body of the electronic device in the floating state. Even when vibration is produced by the actuator, the panel can be stably vibrated within the displacement space, and in the state in which the panel floats from the body of the electronic device. Accordingly, a maximum haptic feedback can be provided to the user.

In addition, it is possible to fix the panel in the floating state, in which the panel is floating from the electronic device, to prevent the panel from being separated from the electronic device and to limit a space in which the panel is displaced when the panel is vibrated. The panel is provided in the state in which it is floating from the display bracket of the electronic device and stably fixed in the floating state. Thus, a maximum haptic feedback can be provided from the panel, and even when the panel endures a shock, for example due dropping the electronic device, the panel can be maintained in the state in which it is stably fixed to the body of the electronic device, whereby the reliability of the electronic device can be secured.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. An electronic device with a floating panel, comprising:
a display bracket;
a panel provided on a front side of the display bracket and configured to sense a touch input and to provide visual information;
an actuator provided on the panel, and configured to provide a haptic signal corresponding to the touch input;
an elastic member provided between the panel and the display bracket, and configured to elastically support the panel to float in a state in which the panel is spaced from the display bracket; and
a stopper configured to fix the panel, which is lifted and supported by the elastic member, to the display bracket in a floating state.

2. The electronic device of claim 1, wherein the stopper comprises:
a first locking plate that is bent and protrudes toward the display bracket along the periphery of the panel;
a second locking plate that is bent and protrudes toward the panel along the periphery of the display bracket, the second locking plate being engaged with the first locking plate in such a manner that the second locking plate forms a space in cooperation with the first locking plate to limit vertical movement of the panel; and
an elastic body that is provided in the space to provide resilience according to the floating of the panel, and to limit horizontal movement of the panel.

3. The electronic device of claim 2, wherein the first locking plate is formed by being bent in an “L” shape below the panel, and the second locking plate is formed by being bent in an inverted “L” shape above the display bracket.

4. The electronic device of claim 3, wherein the elastic member provides elastic force in a direction away from the display bracket to enable the panel to float, and
the elastic body provides resilience to the panel in the floating state.

5. The electronic device of claim 4, wherein the elastic body is formed from at least one of poron, foam, and a spring.

6. An electronic device having a floating panel, comprising:
a display bracket;
a panel provided on a front side of the display bracket and configured to sense a touch input and to provide visual information;
an actuator provided on the panel, and configured to provide a haptic signal corresponding to the touch input; and
a stopper member configured to elastically support the panel in a state in which the panel floats in spaced relation from the display bracket, and to limit a displacement space for the panel when the panel is being vibrated.

7. The electronic device of claim 6, wherein the stopper member comprises:
an elastic member provided between the panel and the display bracket, and configured to elastically support the panel to float in a state in which the panel is spaced from the display bracket; and
a stopper configured to limit a displacement space for the panel which is vibrated as the actuator is driven, and to prevent the panel from separating from the electronic device when the panel is floating.

8. The electronic device of claim 7, wherein the stopper is joined to the elastic member through the display bracket to limit the displacement space for the panel and the separation of the panel.

9. The electronic device of claim 8, wherein the elastic member comprises:
a plate that is provided between a bottom side of the panel and the display bracket, and is formed with a plurality of elastic strips on a side of the display bracket; and
a peripheral area integrally extending from a periphery of the plate and configured to be engaged with a periphery of the panel, the peripheral area being formed with a stopper joint section, and the stopper being joined to the stopper joint section.

10. An electronic device of claim 9, wherein an arrangement section is formed along the peripheral area of the display bracket, the stopper being arranged in the arrangement section, and
wherein the arrangement section is formed with at least one opening so that the stopper is fastened to the stopper joint section through the display bracket.

11. The electronic device of claim 10, wherein the at least one opening comprises first and second openings which are spaced from each other, and
wherein a first side portion of the stopper is engaged in the first opening, and a second side portion of the stopper is engaged in the second opening

12. The electronic device of claim 11, wherein the stopper comprises:
a body portion fastened to the stopper joint section through the opening from a bottom side of the display bracket; and
an elastic body formed on the body portion and configured to provide resilience to the panel that is floating by the plurality of elastic strips.

13. The electronic device of claim 12, wherein the body portion comprises:
first and second body portions fastened to the stopper joint section through the first and second openings; and
a central body portion that is bent and extends between the first and second body portions.

14. The electronic device of claim 13, wherein the elastic body comprises:
first and second leaf springs formed on the first and second body portions to protrude in a direction away from the panel; and
a central leaf spring formed on the central body portion to protrude toward the panel.

15. The electronic device of claim 14, wherein each of the first and second body portions is formed with a fastening hole at an end, and a fastening member extends through each of the fastening holes to be fastened to the peripheral area, thereby fixing the stopper to the elastic member.

16. The electronic device of claim 15, further comprising:
a stopper bracket configured to cover the leaf springs on the arrangement section, and to be joined with the display bracket.

17. The electronic device of claim 16, wherein the arrangement section is formed with fastening openings at sides corresponding to the first and second openings, and the stopper bracket is fastened to the fastening openings.

18. The electronic device of claim 12, further comprising:
a vertical fixing pole provided on the stopper joint section and configured to be fitted through the body portion to limit leftward and rightward movement of the stopper.
